(19) United States
(12) Patent Application Publication
(10) Pub. No.: US 2015/0068823 A1
(43) Pub. Date: Mar. 12, 2015

(54) UNDERCARRIAGE FOR A POWER MACHINE

(71) Applicant: Clark Equipment Company, West Fargo, ND (US)

(72) Inventor: Donovan D. Knutson, Gwinner, ND (US)

(21) Appl. No.: 14/145,579

(22) Filed: Dec. 31, 2013

Related U.S. Application Data
(60) Provisional application No. 61/875,885, filed on Sep. 10, 2013.

(51) Int. Cl. B62D 55/15; B62D 55/30; B62D 55/108

(52) U.S. Cl. CPC B62D 55/15; B62D 55/108; B62D 55/30
USPC 180/9.1; 305/133

(57) ABSTRACT

This disclosure is related to undercarriages for power machines that have tracks as tractive elements. In some embodiments, an adjustable idler mounting structure for an idler pulley in a track assembly is disclosed. In other embodiments, a roller mounting structure for attaching a roller to a track frame is disclosed. In yet other embodiments, an idler pulley is disclosed.

### CROSS-REFERENCE TO RELATED APPLICATION

The present application is based on and claims the benefit of U.S. provisional patent application Ser. No. 61/875,885, filed Sep. 10, 2013, the content of which is hereby incorporated by reference in its entirety.

### BACKGROUND

This disclosure is directed toward power machines. More particularly, this disclosure is related to the undercarriage for power machines that employ endless tracks as tractive elements. Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices) that can be manipulated to perform a work function. Work vehicles include loaders, excavators, utility vehicles, tractors, and trenchers, to name a few examples.

Tractive elements are devices that engage a support surface such as the ground to cause the power machine to move over the support surface. Many power machines employ wheels as tractive elements, but other power machines employ endless tracks, skids, or any combination of tractive elements. Some undercarriages that include endless tracks include track frames with various components mounted to them for the purpose of engaging the endless track and provide proper tensioning of the endless track. These components typically include idlers, rollers, or some combination of idlers and rollers.

Power machines that employ one or more endless tracks as tractive elements utilize various components such as rollers and idlers to maintain proper tension on the endless tracks as they move over a support surface, such as the ground. Such rollers and idlers are coupled to a track frame via various members, which in some instances provide for a variable suspension mounting, as opposed to a rigid mounting. One such suspension mounting for rollers on a power machine is described in U.S. Pat. No. 7,552,785.

The suspension mounting for rollers described in U.S. Pat. No. 7,552,785 includes a plurality of leaf springs stacked together to provide increasing spring force as the wheels or track rollers are deflected. Each stack of springs is coupled to a track roller and is held together by a block on the opposing end of the springs relative to the track roller. The block on each of the spring stacks or assemblies serves as a stop block for the spring assembly positioned forward of it. This stop block was designed to interfere with the wheel end of the spring assembly to limit upward travel of the spring.

The discussion above is merely provided for general background information and is not intended to be used as an aid in determining the scope of the claimed subject matter.

### SUMMARY

This summary and the abstract are provided to introduce a selection of concepts in a simplified form that are further described below in the Detailed Description. The summary and the abstract are not intended to identify key features or essential features of the claimed subject matter, nor are they intended to be used as an aid in determining the scope of the claimed subject matter.

Disclosed embodiments include undercarriages and components for use in undercarriages for power machines. A disclosed undercarriage, in one embodiment, includes roller mounting structures for mounting rollers to a track frame. The roller mounting structures include one or more of disclosed mono-leaf springs to provide a suspension mounting of the rollers. In another embodiment, the disclosed undercarriage has an adjustable idler mounting structure for coupling an idler to the track frame having various advantageous features. In yet another embodiment, an improved idler is disclosed.

### BRIEF DESCRIPTION OF THE DRAWINGS

FIG. 1 is a side perspective view of a power machine upon which various embodiments of the present disclosure are capable of being employed.

FIG. 2 is a block diagram illustrating components of an undercarriage for a power machine such as the power machine illustrated in FIG. 1.

FIG. 3 is a block diagram of a track frame assembly that is employable with the undercarriage of FIG. 2.

FIG. 4 is a diagrammatic perspective view of an undercarriage of a track vehicle illustrating portions of a track frame assembly according to one illustrative embodiment.

FIG. 5 is a perspective view illustrating one embodiment of a roller assembly configured for use with the undercarriage of FIG. 4.

FIG. 6 is a side view of one embodiment of a roller mounting structure suited for use with the roller assembly illustrated in FIG. 5.

FIG. 7 illustrates an idler mounting structure mounted in the undercarriage of FIG. 4 according to one illustrative embodiment.

FIG. 8 illustrates the idler mounting structure of FIG. 7 with a cutaway perspective to show internal components.

FIG. 9 is an illustration of an undercarriage according to another illustrative embodiment.

FIG. 10 is illustrates a portion of the undercarriage of FIG. 9.

FIG. 11 illustrates an idler pulley according to one illustrative embodiment.

### DETAILED DESCRIPTION

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

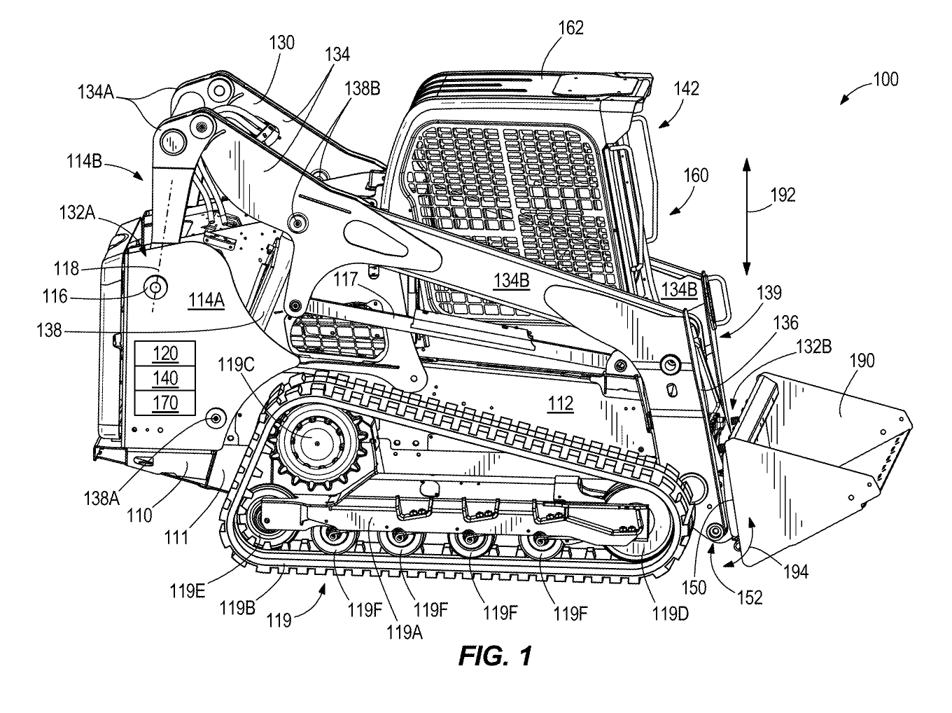

The embodiments discussed below provide illustrative examples of undercarriages for various power machines. In particular, the embodiments illustrate track assemblies and components for track assemblies for undercarriages that include one or more endless tracks as tractive elements. A representative power machine on which the embodiments can be practiced is illustrated in FIG. 1 and described below before any embodiments are disclosed. For the sake of brevity, only one representative power machine is discussed. However, as mentioned above, the embodiments below can be practiced on any of a number of power machines, including power machines of different types from the representative power machine discussed below. Power machines, for the purposes of this discussion, include a frame, at least one work element, and a power source that is capable of providing power to the work element to accomplish a work task. Work vehicles are power machines where at least one of the work elements is a motive system for moving the power machine under power. The disclosed embodiments can be practiced on a power machine such as shown in FIG. 1 or various other power machines that include endless tracks as tractive elements, whether or not the power machine employs other types of tractive elements such as wheels or skids as well.

FIG. 1 is a side elevation view of a representative power machine 100 in the form of a work vehicle upon which the disclosed embodiments can be employed. The representative power machine 100 is a work vehicle in the form of a compact track loader. However, the concepts discussed below can be practiced on many other types of work vehicles such as various types and sizes of loaders including walk behind loaders, excavators, telehandlers, trenchers, graders, dozers, and utility vehicles, to name but a few examples of the many other different types of power machines on which the disclosed embodiments can be practiced.

The power machine 100 includes a frame 110 that supports a power system 120, the power system being capable of generating or otherwise providing power for operating various functions on the power machine. Frame 110 also supports a work element in the form of a lift arm structure 130 that is powered by the power system 120 and is capable of performing various work tasks. As power machine 100 is a work vehicle, frame 110 also supports a power conversion system 140, shown in block form, which is also powered by power system 120 and is capable of providing power to work elements such as the lift arm structure 130 and tractive elements to perform various work tasks including propelling the power machine over a support surface. The lift arm structure 130 supports an implement carrier 150, which is capable of receiving and securing various implements to the power machine 100 for performing various work tasks. The power machine 100 can be operated from an operating position 160 from which an operator can manipulate various control devices to cause the power machine to perform various functions. A control system 170 is provided for controlling the various functions of the power machine 100. The control system 170 is shown in block form in FIG. 1 and can include various components including electronic controllers, user input devices, hydraulic components, or any combination thereof as well as other components as may be appropriate to control various functions on a given power machine.

The elements of frame 110 discussed with respect to power machine 100 are provided for illustrative purposes and should not be considered to be the only type of frame that a power machine on which the embodiments can be practiced can employ. Frame 110 of power machine 100 includes an undercarriage 111 and a mainframe 112 that is supported by the undercarriage. The mainframe 112 of power machine 100 is attached to the undercarriage 111 such as with fasteners (not shown) or by welding the undercarriage to the mainframe. In other power machines on which the discussed embodiments may be practiced, the mainframe portion of the frame can be pivotally mounted to the undercarriage, such as is the case with excavators. In other power machines, the undercarriage can be integrated into the mainframe such that the undercarriage and mainframe together are part of a single frame member. Mainframe 112 includes a pair of upright portions 114A and 114B located on either side of the mainframe that support lift arm structure 130 and to which the lift arm structure 130 is pivotally attached. The lift arm structure 130 is illustratively pinned to each of the upright portions 114A and 114B. The combination of mounting features on the upright portions 114A and 114B and the lift arm structure 130 and mounting hardware (including pins used to pin the lift arm structure to the mainframe 112) are collectively referred to as joints 116 (only one of which is shown in FIG. 1) for the purposes of this discussion. Joints 116 are aligned along an axis 118 so that the lift arm structure is capable of pivoting, as discussed below, with respect to the mainframe 112 about axis 118. Other power machines may not include upright portions on either side of the frame, or may not have a lift arm structure that is mountable to upright portions on either side of the frame. For example, some power machines may have a single arm, mounted to a single side of the power machine or to a front or rear end of the power machine. Other machines can have a plurality of work elements, including a plurality of lift arms, each of which is mounted to the machine in its own configuration. Frame 110 also supports tractive elements 119, which on power machine 100 are a pair of track assemblies one located on each side of the frame 110, with only one track assembly 119 shown in FIG. 1. Other power machines on which the embodiments can be practiced can have any number and combination of tractive elements, as long as they include at least one track assembly. The track assembly 119 includes a track frame 119A, which is coupled to or, in the case of power machine 100, integral with the undercarriage 111. A track 119B surrounds the track frame 119A. The track 119B is driven around the track frame 119A by a sprocket 119C. A pair of idlers 119D and 119E is operably coupled to the track frame 119A and engages the track 119B to tension the track. Likewise, a plurality of rollers 119F are operably coupled to the track frame 119A and engage the track 119B to tension the track along a support surface with which it is engaged.

The lift arm structure 130 shown in FIG. 1 has a first end 132A that is pivotally coupled to the power machine at joints 116 and a second end 132B that moves under control of the power machine with respect to the frame 110. The movement (i.e. the raising and lowering of the lift arm structure 130) is described by a travel path, which is shown generally by arrow 192. For the purposes of this discussion, the travel path 192 of the lift arm structure 130 is defined by the path of movement of the second end 132B of the lift arm structure.

The lift arm structure 130 of power machine 100 includes a pair of lift arms 134 that are disposed on opposing sides of the frame 110. Each of the lift arms 134 includes a first portion 134A and a second portion 134B that is pivotally coupled to the first portion 134A. The first portion 134A of each lift arm 134 is pivotally coupled to the frame 110 at one of the joints 116 and the second portion 134B extends from its connection to the first portion 134A to the second end 132B of the lift arm structure 130. The lift arms 134 are each coupled to a cross member (not shown) that is attached to the second portions 134B. The cross member provides increased structural stability to the lift arm structure 130. A pair of actuators 138 (only one is shown in FIG. 1), which on some power machines, including power machine 100, are hydraulic cylinders configured to receive pressurized fluid from power conversion system 140, are pivotally coupled to both the frame 110 and the lift arms 134 at pivotable joints 138A and 138B, respectively, on either side of the power machine 100. The actuators 138 are sometimes referred to individually and collectively as lift cylinders. Actuation (i.e., extension and retraction) of the actuators 138 cause the lift arm structure 130 to pivot about joints 116 and thereby be raised and lowered along a fixed path indicated by travel path arrow 192, which is generally a vertical path. A pair of control links 117 (only one is shown) are pivotally mounted to the frame 110 and the lift arm structure 130 on either side of the frame. The control links 117 help to define the vertical travel path of the lift arm structure. The lift arm structure 130 is representative of one type of lift arm structure that may be coupled to the power machine 100. Other lift arm structures, with different geometries, components, and arrangements can be pivotally coupled to the power machine 100 or other power machines upon which the embodiments discussed herein can be practiced without departing from the scope of the present discussion. For example, other machines can have lift arm structures that are pivotally coupled to a frame that have a generally radial travel path. Other lift arm structures can have an extendable or telescoping lift arm. Still other lift arm structures can have multiple (i.e. more than two) portions segments. Some lift arms, most notably lift arms on excavators, can have portions that are controllable to pivot with respect to another segment instead of moving in concert as is the case in the lift arm structure 130 shown in FIG. 1. Some power machines have lift arm structures with a single lift arm, such as is known in excavators or even some loaders and other power machines. Other power machines can have a plurality of independently actuable lift arms, such as is the case with tractor loader backhoes.

In some power machines, including power machine 100, the power conversion system 140 includes hydraulic components such as one or more hydraulic pumps, various actuators, and other components that are illustratively employed to receive and selectively provide power signals in the form of pressurized hydraulic fluid to some or all of the actuators used to control functional components of the power machine 100. For example, a control valve assembly (not separately shown) is used to selectively provide pressurized hydraulic fluid from a hydraulic pump to actuators such as hydraulic cylinders that are positioned on the power machine. Power conversion system 140 also selectively provides pressurized hydraulic fluid to a port 139, to which an implement can be coupled for receiving pressurized hydraulic fluid. Other power machines upon which the disclosed embodiments can be practiced can employ other power conversion systems. For example, some power machines have power conversion systems that include electric generators or the like to generate electrical control signals to power electric actuators. Still other power machines have mechanical transmissions that act as a power conversion system, at least so far as a drive system is concerned.

Power machine 100 is capable of being operably coupled to an implement 190, which is a simple bucket. Other implements can have power devices, which are configured to receive power from the power machine 100 via port 139. Port 139 can include a power source in the form of hydraulic fluid, but can also or alternatively include an electrical power source. Other power machines can include a mechanical power source such as power takeoff. Power machine 100 can control an attached implement either by positioning the implement, providing a power source to the implement, or both.

The power machine 100 includes an implement carrier 150, which is configured to receive and secure an implement to the power machine. Implement carrier 150 shown in FIG. 1 is pivotally coupled to the lift arm structure 130 along an axis that runs through joints 152 on each of the lift arms 134. The pivotally coupled implement carrier 150 is positionable under control of the power machine 100 via one or more actuators. In the case of power machine 100, a pair of hydraulic cylinders 136 (one of which is shown) are pivotally coupled to the implement carrier 150 and the lift arm structure 130 to cause the implement carrier to rotate under power about an axis that extends through the joints 152 in an arc approximated by arrow 194 in response to operator input. Hydraulic cylinders 136 are capable of receiving pressurized hydraulic fluid from the power conversion system 140 in response to actuation of operator inputs by an operator. The hydraulic cylinders 136 are sometimes referred to as tilt cylinders.

As mentioned above, the implement carrier 150 is configured to accept and secure any one of a number of different implements to the power machine 100 as may be desired to accomplish a particular work task. Other power machines can include different styles of implement carriers that are designed accept various different implements. Still other power machines may have lift arm assemblies without an implement carrier and instead require that implements such as a bucket are pinned directly onto the lift arm assembly.

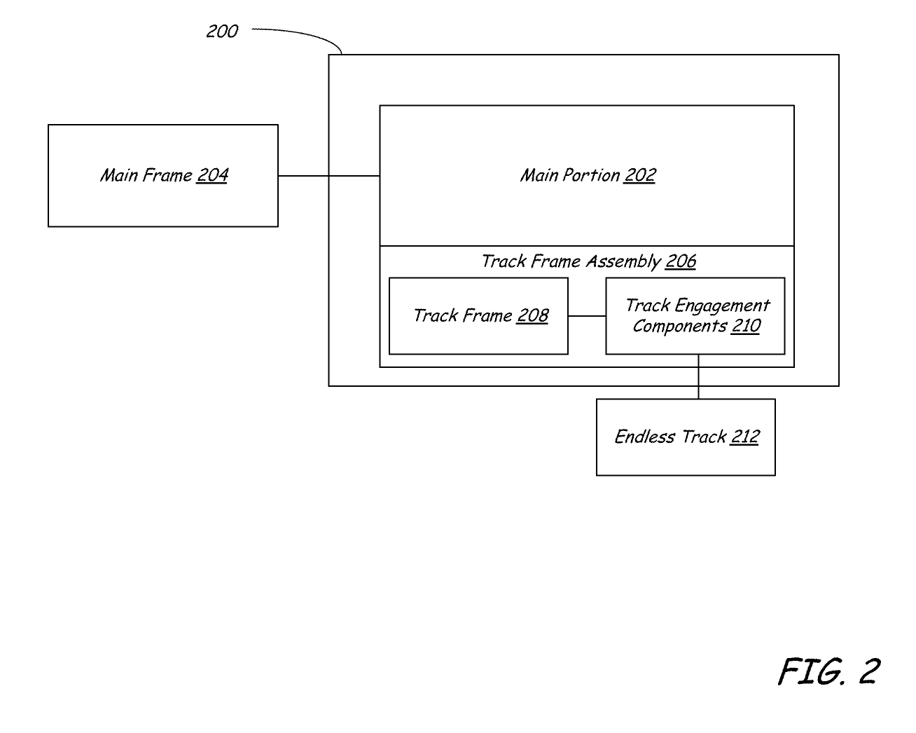

FIG. 2 is a block diagram identifying components of an undercarriage 200 for a power machine that employs endless tracks as tractive elements according to the illustrative embodiments. Undercarriage 200 is generally representative of any of a number of different embodiments, including the undercarriage 119 illustrated in FIG. 1. Most basically, the undercarriage 200 includes a main portion 202, which supports a main frame 204 of the power machine. Main frame 204, in some embodiments, is integral with or rigidly mounted on, the undercarriage. One example of a power machine that has a main frame rigidly mounted on its undercarriage is power machine 100 illustrated in FIG. 1. Other power machines such as excavators have a main frame that is movably mounted to its undercarriage. For the purposes of this diagram, the main frame 204 refers not only to a main frame portion of the power machine, but to any other structures (cabs, lift arms, and the like) that may be attached to the main frame.

The undercarriage 200 includes at least track frame assembly 206, which is coupled to the main portion 202. The track frame assembly 206 includes a track frame 208 and track engagement components 210. The track frame 208 can be removably attached to the main portion 202 such as with fasteners or integrated into the main portion. An integrated track frame can be welded to the main portion of the undercarriage or otherwise integrated, as opposed to being a standalone component that is attached to the main portion of the undercarriage. The track frame 208 provides a structure to carry endless tracks 212. The track engagement components 210 are provided to engage the endless tracks 212 for providing proper tensioning on the tracks 212 as well as driving the tracks over a support surface.

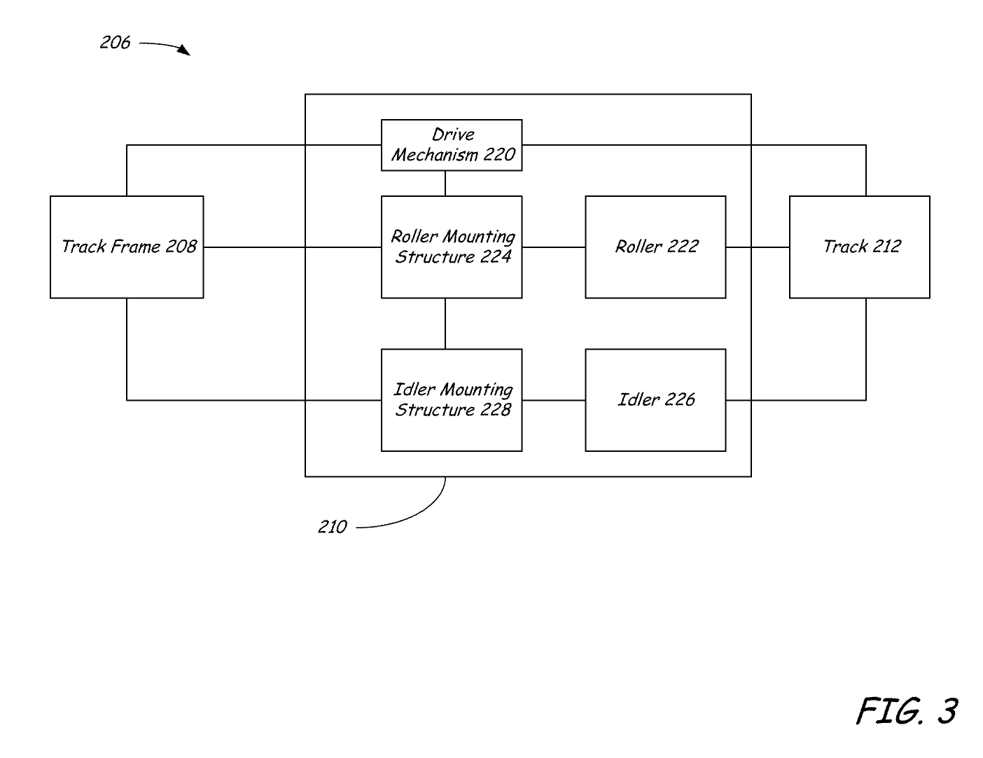

FIG. 3 illustrates the track frame assembly 206 in more detail, showing the track frame 208 and a plurality of track engagement components 210 that engage track 212. The track engagement components 210 include a drive mechanism 220, which engages the track 212 to drive the track over the support surface. The drive mechanism 220 is shown as being operably coupled to the track frame 208, but in some embodiments is actually coupled to the main portion 202 of the undercarriage 200. Track mechanism 220, in some embodiments, is a sprocket that is driven by a power conversion system on the power machine.

The track engagement components 210 can also include one or more idlers 226, which provide the appropriate tension to the track 212. Each of the one or more idlers 226 is coupled to the track frame 208 via an idler mounting structure 228. In some embodiments, a pair of idlers 226 is provided to tension track 212, with at least one of the idler mounting structures 228 being a variable tensioning device to allow for adjustment of the track tension. One or more of the idlers 226 can have idler mounting structures 228 that fix the position of such idlers to the track frame 208.

In addition, track engagement components 210 can include one or more rollers 222 that engage the track to apply tension onto the support surface. Each of the one or more rollers 222 is coupled to the track frame 208 via a roller mounting structure 224. In some embodiments, one or more of the roller mounting structures 224 can rigidly mount one or more of the rollers 224 to the track frame 208. In other embodiments, one or more of the roller mounting structures 224 are flexible so as to provide a flexible coupling between the track frame 208 and one or more of the rollers.

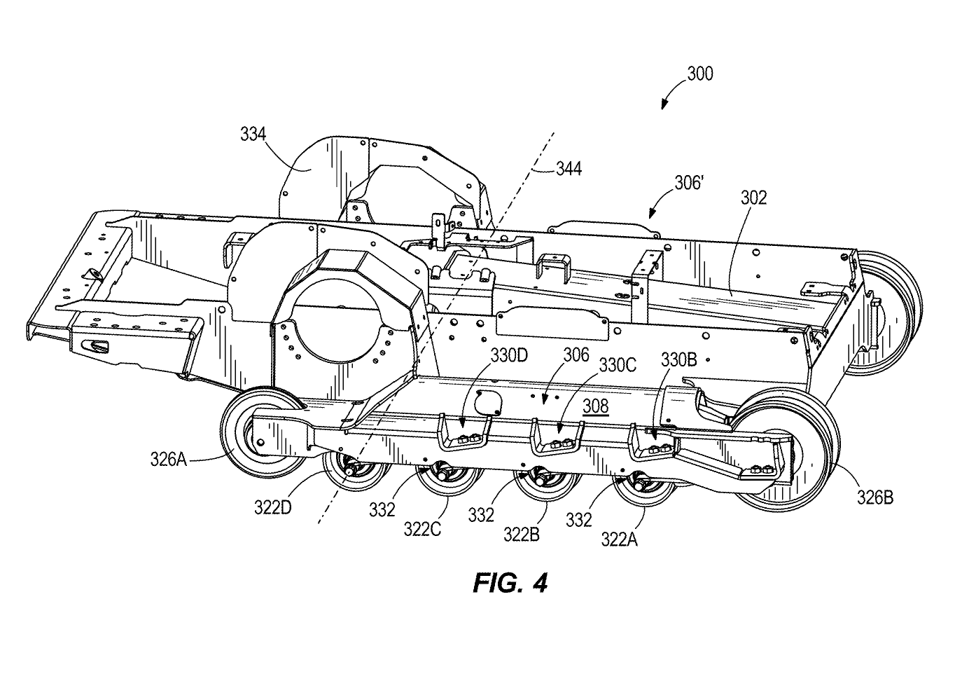

FIG. 4 illustrates an undercarriage 300, which is one embodiment of an undercarriage that incorporates features described generally above with respect to the undercarriage 200 of FIGS. 2-3. More particularly, undercarriage 300 includes idlers and rollers with idler and roller mounting structures that include advantageous features. While undercarriage 300 is described as having both of the advantageous idler and roller mounting structures, other embodiments may include the same or similar idler of either the mounting structures or roller mounting features, but not both.

The undercarriage 300 in FIG. 4 is of the type that can be employed with power machine 100 and is shown without the remaining frame and tracks for the sake of clarity. Undercarriage 300 includes a main portion 302 with track frame assemblies 306 and 306′ on either side of the main portion 302. Track frame assemblies 306 and 306′ are substantially similar and only track frame assembly 306 is described here. The undercarriage 300 shown in FIG. 3 is a one-piece undercarriage, although in other embodiments, track assemblies of the type described here can be employed on undercarriages that are not one-piece undercarriages. For the purposes of this discussion, a one-piece undercarriage has track frames 308 that are an integral part of the undercarriage 300 as opposed to being fastened or bolted onto the undercarriage. The one-piece undercarriage 300 can be formed of a single piece of material, but multiple pieces that are welded together into a rigid assembly is also, for the purposes of this discussion, a one-piece undercarriage. The primary distinction between a one-piece undercarriage for tracked vehicles versus other undercarriages is that the track frames on one-piece undercarriages are integrated into the undercarriage instead of being removably attached to the undercarriage using bolts and fasteners.

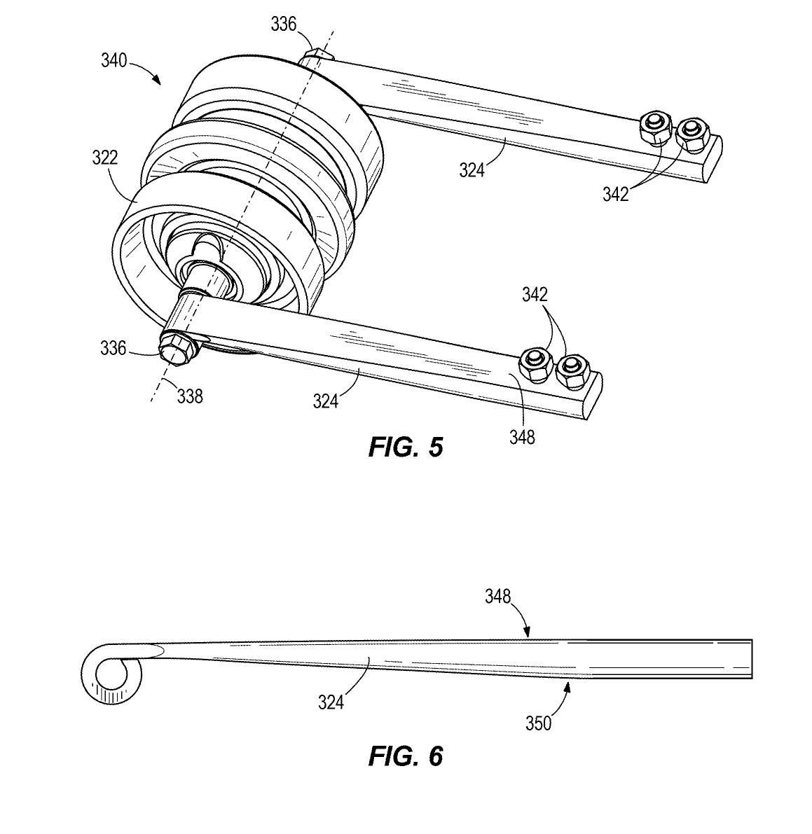

The track frame assembly 306 has a variety of track engagement components with unique features, including a pair of idlers 326A and 326B. Idler 326A is coupled to the track frame 308 so that it remains in a fixed position, while idler 326B is coupled to the track frame 308 via an adjustable idler mounting structure (not shown in FIG. 4) so that idler 326B is moveable with respect to the track frame 308. Track frame assembly 306 also includes a plurality of rollers 322A-322D (collectively 322), each of which is coupled to the track frame 308 via flexible roller mounting structures (324A-324D, shown in FIG. 5, collectively 324) that are mounted to the track frame 308 at mounting locations 330A-330D. The flexible roller mounting structures 324A-324D provide a cushioning or shock absorbing effect, which results in a smoother riding experience for an operator of a power machine that employs such roller mounting structures. In some embodiments, the roller mounting structures 324 are pre-loaded. That is, the roller mounting structures 324 are attached the track frame 308 at an angle such that the roller mounting structures 324 apply a downward force on the rollers 322 under normal conditions. Pre-loading the roller mounting structures 324 tends to reduces oscillation about an axis that is parallel an axis 344 that extends through the roller 322D or any other of the rollers. In other embodiments, though, the roller mounting structures 324 are not preloaded. Four rollers 322 and associated roller mounting structures 324 are shown in FIGS. 4-5, but any number rollers can be employed in various embodiments. The roller mounting structures 324 are mounted to the track frame 308 at roller mounting locations 330A-D such that the roller mounting structures 324A-D are positioned inboard of the track frame. In other words, the track frame 308 provides a protective cover for the roller mounting structures 324A-D. In addition the track frame 308 includes a plurality of engagement features 332 that are positioned to engage the rollers 322 and/or the roller mounting structures 324 to limit the upward deflection of the roller mounting structures 324. In the embodiment shown in FIG. 4, the engagement features 332 are notches formed into the track frame 308 for engaging the rollers 322. Undercarriage 300 also includes a pair of mounts 334 for carrying drive motors (not shown) which are capable of driving sprockets generally similar to the sprocket 119C of FIG. 1 that engage the track.

FIG. 5 illustrates a roller assembly 340 according to one illustrative embodiment that collectively includes roller 322 along with a pair of roller mounting structures 324. Each of the roller mounting structures 324 is a parabolic mono-leaf spring that is attached to either side of the roller 322. The roller mounting structures attached to each of the rollers discussed above with reference to FIG. 4 refer to roller mounting structures 324A-D as if a single mounting structure is provided for teach roller, which may be the case in some embodiments. However, when employing roller assembly 340, each of roller mounting structures 324A-D refers to a pair of roller mounting structures. The roller mounting structures 324 are attached with fasteners 336 or in any other manner that secures the roller mounting structures to the roller 322 while also allowing the roller to rotate about an axis 338 that extends through the fasteners. Fasteners 342 are shown inserted into apertures in the suspension elements 314 in FIG. 5, but when assembled, the fasteners are also inserted through apertures in the track frame 308 to mount the roller assembly 340 to the track frame at roller mounting locations 330. While the embodiment in FIG. 5 shows two roller mounting structures 324, in other embodiments, a single or more than two roller mounting structures 324 can be employed. FIG. 6 shows a side view of roller mounting structure 324. The roller mounting structure 324 is a tapered spring ending in an aperture 344 through which fastener 336 is inserted to attach the roller mounting structure to the roller. One or more apertures (not shown in FIG. 6) extend from a first major surface 348 to a second major surface 350 of the roller mounting structure 324. The apertures are provided to accept fasteners 342 for attachment to the track frame 308. In other embodiments, one or more fasteners can be pressed into roller mounting structure 324 so that the fasteners are fixed to the roller mounting structure 324 instead of being removably inserted into the roller mounting structure as fasteners 342 are.

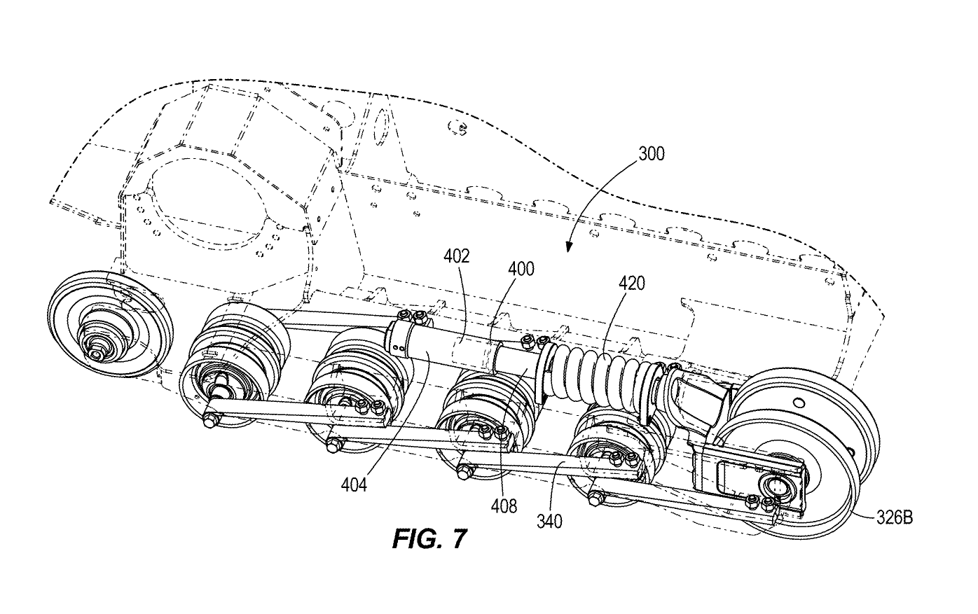

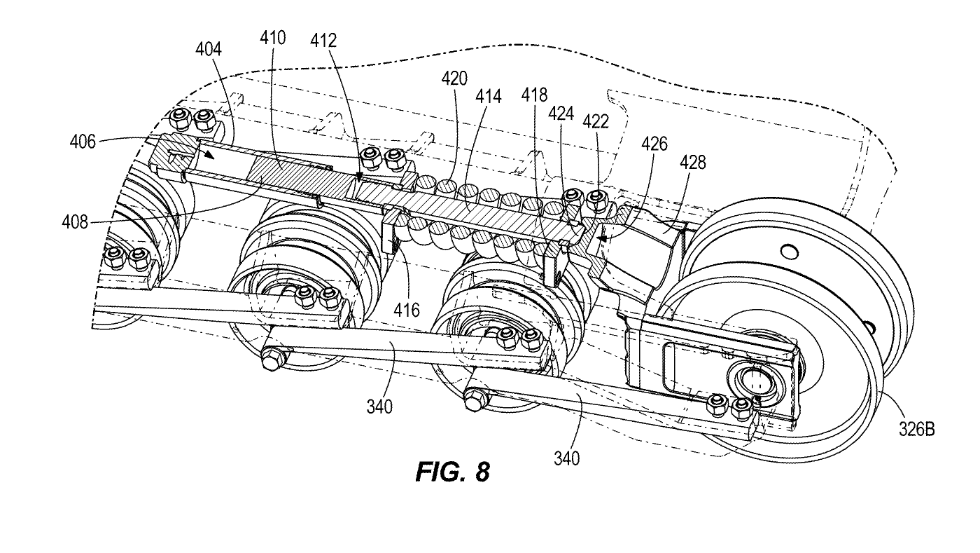

FIGS. 7-8 each illustrate a portion of undercarriage 300 with portions of the track frame 308 removed to illustrate one embodiment of an idler mounting structure 400 for coupling idler pulley 326A to the track frame 308. In FIG. 8, the idler mounting structure 400 is shown in cross-section to illustrate some of its internal features. The idler mounting structure 400 is an adjustable idler mounting structure, capable of positioning the idler pulley 326B to provide for a suitable tension on a track (not shown in FIGS. 7-8). The idler mounting structure 400 includes an actuable cylinder and more particularly, a grease cylinder. Grease cylinders are generally known for use in tensioning tracks, and other types of adjustable devices can be used to tension tracks. However, the idler mounting structure 400 has several advantageous features that distinguish it over a typical idler mounting structure.

The adjustable idler mounting structure 400 is operably coupled to the track frame 308 at one end and to the idler pulley 326B at a second end. The adjustable idler mounting structure 400 includes an adjustment mechanism 402, which as mentioned above, is a grease cylinder. The grease cylinder 402 includes a cylinder body 404 that has a cavity 406 out of which a rod 408 extends on the other end. Rod 408 is a two-piece assembly with a first portion 410 that extends into cavity 406 on one end and has a cavity 412 that can accept a second portion 414 on a second end. The second portion 414 of the rod 408 is operably coupled to the idler pulley 326B. A biasing spring 420 surrounds the second portion 414 and is captured on the second portion 414 by a pair of carriers 416 and 418. The spring 420 biases the second portion 414 to extend the idler pulley 326B. Under a normal tensioning condition, the second portion 414 is positioned to allow an unoccupied pocket in the cavity 412. When a force is applied against the adjustment mechanism 402, for example, due to shock introduced against the idler pulley 326B, the second portion 414 is capable of retracting into the unoccupied pocket and thus absorb a shock that might occur, for example, when a tracked power machine engages uneven terrain or collides with a hard object. The adjustment mechanism 402 of this embodiment thus includes a shock absorption mechanism via the allowed movement of the second portion 414 relative to the first portion 410, restrained by the spring 420.

The second portion 414 of the rod 408 is operably coupled to the idler pulley 326B through a ball joint 422 formed by a ball 424 located at the end of the second portion 414 and a socket 426 formed into a bracket 428 onto which the idler pulley 326B is attached. The ball joint 422 allows for an operable coupling between the adjustment mechanism 402 and the idler pulley 326B while also decoupling the adjustment mechanism side loads that may be introduced from the idler.

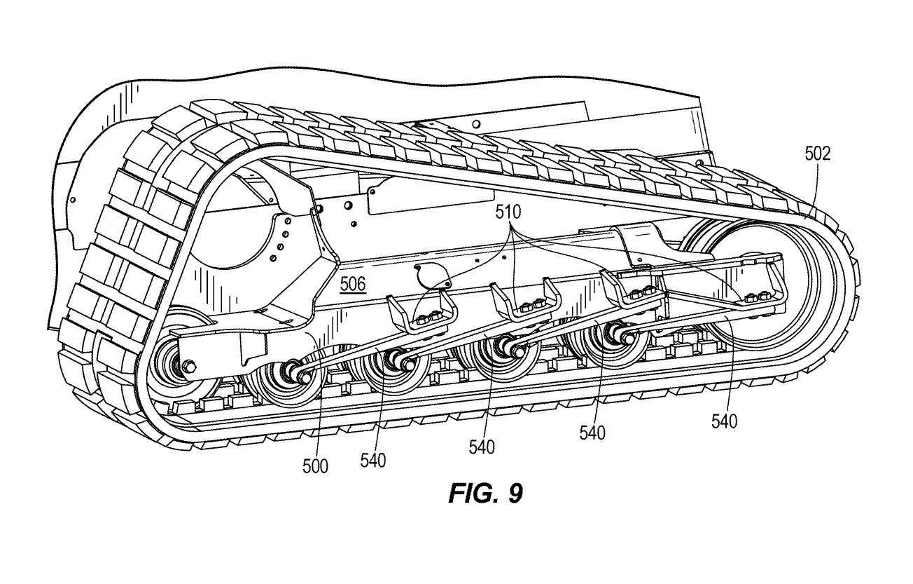

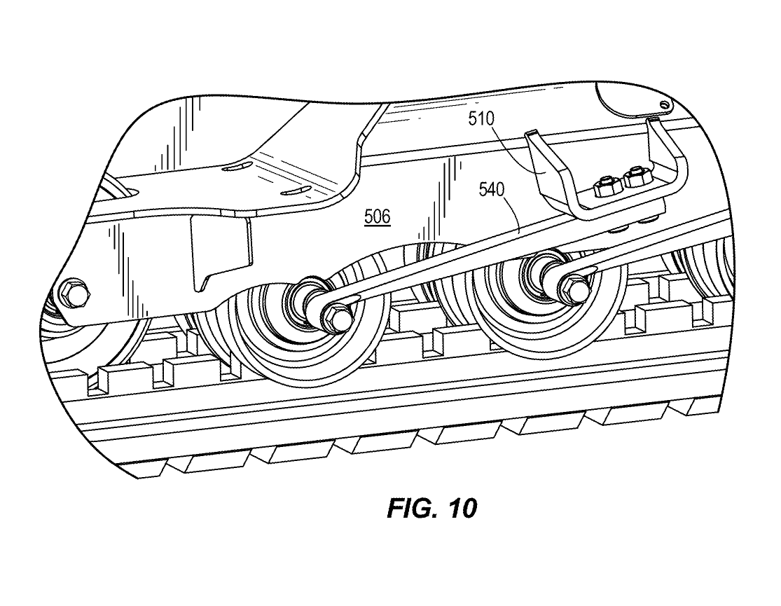

FIGS. 9-10 illustrate another embodiment of a track frame assembly 500 with a track 502 mounted on over a track frame 508. The track frame assembly 500 is generally similar to the track frame assembly 306 except that roller assemblies 540 are mounted to the track frame 508 to flanges 510 so that roller mounting structures 524 are outboard of the track frame 508.

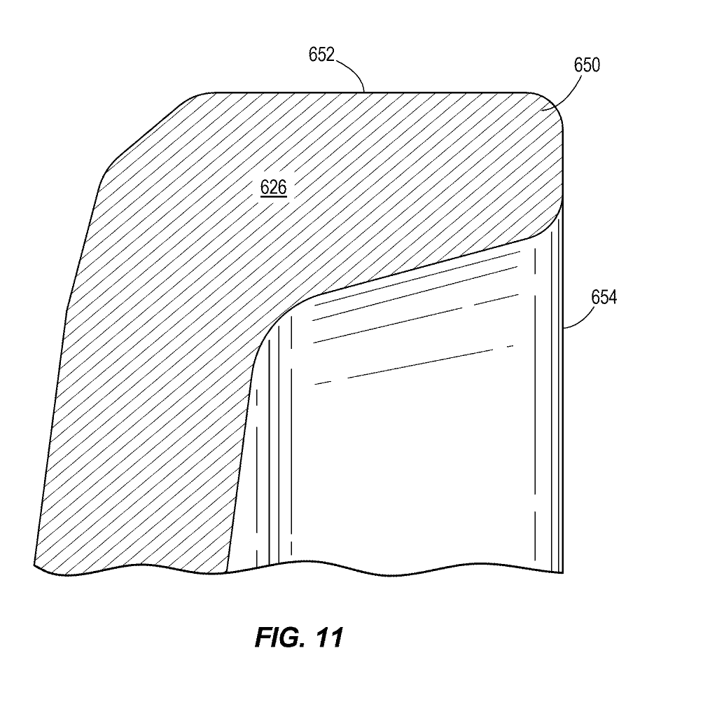

FIG. 11 illustrates a cross-sectional view of an embodiment of an idler pulley 626 that can be used with track assemblies of the type discussed above. The portion of the idler pulley 626 shown in FIG. 11 illustrates a radius 650 that joins an idler flange edge 652 with an idler rolling face 654. The radius 650 is shaped such that it has tangency with only the idler rolling face 654 and not the idler flange edge 652. The resulting radius 650 has advantageously prevented premature wearing of tracks by eliminating a relatively sharp edge that might otherwise chafe against a track. Prior art idler pulleys have included a small radius that achieves tangency with both the idler flange edge and the idler rolling face.

The embodiments discussed above introduce concepts that provide several advantages. Among those advantages are roller assemblies that are capable of providing improved suspension capabilities, resulting in improved operator comfort over prior art track suspension systems. Other advantages include an adjustable mechanism for tensioning idler pulleys that allow for improved shock absorption and capabilities of withstanding side loads. Improved idler pulleys are disclosed, which will improve the life of rubber tracks by reducing friction induced wear through engagement with an idler pulley.

Although the present invention has been described with reference to preferred embodiments, workers skilled in the art will recognize that changes may be made in form and detail without departing from the spirit and scope of the invention.

What is claimed is:

1. A roller assembly for use in a track assembly of a tracked power machine, the roller assembly comprising:
a roller configured to engage a track of the power machine;
at least one roller mounting structure configured to couple the roller to a track frame of the power machine, the at least one roller mounting structure including a mono-leaf spring having an aperture through which the roller is attached to the mono-leaf spring.

2. The roller assembly of claim 1, wherein the roller mounting structure includes a second mono-leaf spring having an aperture through which the roller is attached to the second mono-leaf spring.

3. The roller assembly of claim 2, wherein the mono-leaf spring and the second mono-leaf spring of the roller mounting structure form a pair of mono-leaf springs and are disposed on opposing sides of the roller.

4. The roller assembly of claim 1, and further comprising multiple rollers configured to engage the track of the power machine.

5. The roller assembly of claim 1, wherein the roller mounting structure includes a fastener configured to be accepted in the aperture of the mono-leaf spring to attach the roller to the mono-leaf spring.

6. The roller assembly of claim 1, wherein the mono-leaf spring is a parabolic mono-leaf spring.

7. The roller assembly of claim 1, wherein the mono-leaf spring is a tapered spring ending in the aperture through which the roller is attached to the mono-leaf spring.

8. The roller assembly of claim 1, wherein the mono-leaf spring includes at least one frame mounting aperture extending from a first major surface of the mono-leaf spring to a second major surface of the mono-leaf spring to accept fasteners for attachment of the roller assembly to a track frame structure.

9. A track assembly for a tracked power machine, the track assembly comprising:
a track frame;
a track; and
a roller assembly coupled to the track frame, the roller assembly including:
a roller configured to engage the track;
a roller mounting structure configured to couple the roller to the track frame, the roller mounting structure having a mono-leaf spring to which the roller is attached.

10. The track assembly of claim 9, wherein the roller mounting structure includes a second mono-leaf spring to which the roller is attached, the mono-leaf spring and the second mono-leaf spring of the roller mounting structure forming a pair of mono-leaf springs disposed on opposing sides of the roller.

11. The track assembly of claim 10, and further comprising a plurality of rollers configured to engage the track.

12. The track assembly of claim 10, and further comprising a plurality of roller assemblies coupled to the track frame.

13. The track assembly of claim 9, wherein the roller mounting structure includes a fastener configured to be accepted in an aperture of the mono-leaf spring to attach the roller to the mono-leaf spring.

14. The track assembly of claim 9, wherein the mono-leaf spring is a parabolic mono-leaf spring.

15. The track assembly of claim 9, wherein the mono-leaf spring includes at least one aperture extending from a first major surface of the mono-leaf spring to a second major surface of the mono-leaf spring, the track assembly further comprising at least one fastener extending through the at least one aperture to attach the roller assembly to the track frame.

16. A power machine, comprising:
a frame;
a track assembly coupled to the frame for providing tractive effort to cause the power machine to move over a support surface, including:
a track frame;
a track capable of movement about the track frame;
an idler in communication with the track to provide tension to the track; and
an adjustable mounting structure coupled to the track frame and the idler for supplying tension to the track via the idler, wherein the adjustable mounting structure includes:
a cylinder with a two-piece rod with a first portion of the rod capable of accepting a portion of a second portion, the second portion being coupled to the idler and moveable within and with respect to the first portion; and
a spring member acting against the first portion and the second portion.

17. The power machine of claim 16 and further comprising:
a roller assembly mounted to the track frame for engaging the track, the roller assembly having a roller and a roller mounting structure coupled to the coupled to the track frame and the roller, the roller mounting structure including a mono-leaf spring.

18. The power machine of claim 17, wherein the roller mounting structure of the roller assembly includes a second mono-leaf spring, the mono-leaf spring and the second mono-leaf spring forming a pair of mono-leaf springs disposed on opposing sides of the roller.

19. The power machine of claim 17, wherein the track assembly includes a plurality of roller assemblies.

20. The power machine of 16, wherein the idler has a radius that joins an idler flange edge with an idler rolling face.
